(19) United States
(12) Patent Application Publication
(10) Pub. No.: US 2006/0078050 A1
(43) Pub. Date: Apr. 13, 2006

(54) System and method for increasing SVC compressing ratio

(75) Inventor: Hsin-Hao Chen, Hsinchu (TW)

Correspondence Address: BIRCH STEWART KOLASCH & BIRCH, PO BOX 747, FALLS CHURCH, VA, 22040-0747, US

(73) Assignee: INDUSTRIAL TECHNOLOGY RESEARCH INSTITUTE

(21) Appl. No.: 11/133,249

(22) Filed: May 20, 2005

(30) Foreign Application Priority Data
Oct. 11, 2004 (TW) 93130748

(51) Int. Cl. H04N 11/04; H04N 11/02; H04B 1/66; H04N 7/12

(52) U.S. Cl. 375/240.11; 375/240.19; 375/240.16; 375/240.23; 375/240.24

(57) ABSTRACT

A system for increasing the compressing ratio in scalable video coding and the method thereof perform predictive video coding in the spatial low sub-bands of the temporal low sub-band picture in the group of pictures after the temporal filtering and spatial discrete wavelet transform. This determines an optimized predictive mode and the related information of the temporal low sub-band picture with the highest energy as the primary reference for actual video coding. Accordingly, the system and method will achieve the goals of reducing the compressed coding data and thus increasing the compressing ratio in the scalable video coding.

### BACKGROUND OF THE INVENTION

1. Field of Invention

The invention relates to a video coding system and the method thereof. In particular, the invention pertains to a system that can increase the compressing ratio of scalable video coding (SVC) by reducing the coding data through an optimal prediction for the temporal low sub-band picture with the highest energy and the method thereof.

2. Related Art

The scalable video coding (SVC) is the latest video coding standard. Its primary purpose is to adjust the resolution, quality or transmission rate per second of the video pictures according to the transmission environment. To achieve the scalability, common wisdom is that spatial discrete wavelet transform (DWT) in more feasible than discrete cosine transform (DCT). Therefore, the DWT is the mainstream of the transform coding technique in the SVC structure.

Taking the MCTF_EZBC (a motion compensated temporal filtering structure) as an example of the SVC structure, it mainly uses the group of pictures (GOP) as the basic unit for compressing. First, it performs a motion estimation, finding out the motion vectors in each consecutive two pictures. Afterwards, temporal filtering is done along the picture motion direction to generate temporal high- and low-band pictures, decreasing the temporal redundancy to achieve the goal of reducing the data compression. Through continuous levels of executions, only one temporal low sub-band picture of the GOP is left (as 10 in FIG. 2). To satisfy the scalability of the resolution, said SVC structure further performs spatial wavelet decomposition on all pictures after spatial filtering. The more levels there are, the more scalable levels there are in the resolution. After each level of DWT, each picture produces four sub-bands in the spatial axis. After the next level of DWT, each of the low sub-bands is further divided into four sub-bands. According to different scalability requirements, such processes can be continued (e.g. FIG. 3 shows a three-level processing). Finally, the coefficients obtained from the DWT are processed using entropy coding. The correlation among the coefficients is further coded to increase the overall compressing ratio.

Although the above-mentioned example is a complete scalable SVC structure, the last one temporal low sub-band picture left from the temporal filtering does not have too many processes about the coding. Therefore, the compressing ratio cannot be optimized in the prior art for the temporal low sub-band picture with the most data. Consequently, the overall compressing ratio is reduced.

A related prior art, e.g. the H.264 SVC structure, proposes a technique to increase the I picture compressing ratio by perform an internal estimation on the I picture. In addition, we also find that the US2004/0008771A1 has proposed a coding technique for a single digital picture. It mainly divides the digital picture into several blocks of the same size. Before coding each block, the prediction modes used in its adjacent blocks are found out first. The usage frequencies of these prediction modes used in its adjacent blocks are used to determine the prediction mode of the current block, achieving efficient coding for the single digital picture.

Therefore, under the rapidly developing SVC structures, how to effectively reduce the coding data in the SVC structure without sacrificing the picture quality and at the same time maintain the scalability of the SVC structure for increasing the compressing ratio is the primary research direction in the field.

### SUMMARY OF THE INVENTION

In view of the foregoing, an objective of the invention is to provide a new SVC system and the method thereof. The invention performs predictive video coding on the spatial low sub-bands of the temporal low sub-band picture in the GOP after temporal filtering and spatial DWT processing to determine an optimized predictive mode and the related information of the temporal low sub-band picture with the largest data quantity, which are then taken as the reference for actual video coding. This helps achieving the goals of reducing coding data and enhancing the compressing ratio of video coding.

To achieve the above goals, the disclosed system includes: a motion estimating unit, a motion compensated temporal filtering unit, a DWT unit, a motion vector coding unit, a video coding unit, and a buffering unit. It has the feature that: a video coding predictive unit is inserted between the DWT unit and the video coding unit to perform video coding predictions toward the temporal low sub-band picture, reduce coding data, and increase the compressing ratio.

In a first embodiment of the invention, the method includes the steps of: dividing spatial low sub-bands into several predictive blocks of the same size; reading in sequence the predictive blocks and making video coding predictions on all pixels in the predictive blocks according to the video coding predictive mode, thereby generating predictions for each of the predictive blocks; computing the actual values associated with the predictive blocks to compare with the prediction, thereby determining the optimized modes of the predictive blocks and the corresponding differences; outputting the optimized predictive modes and differences associated with the predictive blocks as the primary references for video coding on temporal low sub-band picture.

In a second embodiment disclosed herein, we only perform the video coding presetting on the predictive block of the single spatial low sub-bands as in the first embodiment. After statistical analysis on the optimized predictive modes of all the predictive blocks in the spatial low sub-bands, the invention determines the most representative optimized predictive mode and uses it as the primary video coding reference on the temporal low sub-band picture.

### BRIEF DESCRIPTION OF THE DRAWINGS

The invention will become more fully understood from the detailed description given hereinbelow illustration only, and thus are not limitative of the present invention, and wherein:

FIG. 1 shows the system structure of the invention;

FIG. 2 is a schematic view of the temporal filtering in the motion compensated temporal filtering unit according to the invention;

FIG. 3 is a schematic view of the spatial wavelet decomposition in the discrete wavelet transform unit according to the invention;

FIG. 4 is a schematic view of the computation reference direction according to the disclosed coding prediction mode;

FIG. 5 is a schematic view of the computation reference according to the disclosed coding prediction mode;

FIG. 6 is a flowchart of the first embodiment of the invention; and

FIG. 7 is a flowchart of the second embodiment of the invention.

### DETAILED DESCRIPTION OF THE INVENTION

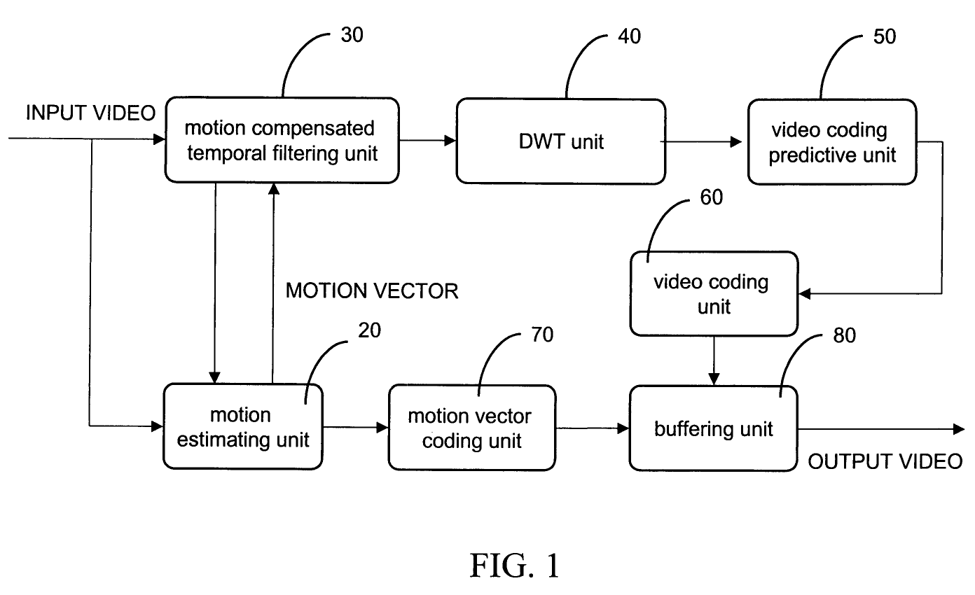

The disclosed system structure is shown in FIG. 1 to perform video coding predictive processing on the temporal low sub-band picture 10 with the largest data quantity in a GOP based upon a SVC structure. It includes the following parts:

(a) Motion estimating unit 20. It estimates the motion vector among the pictures in the GOP.

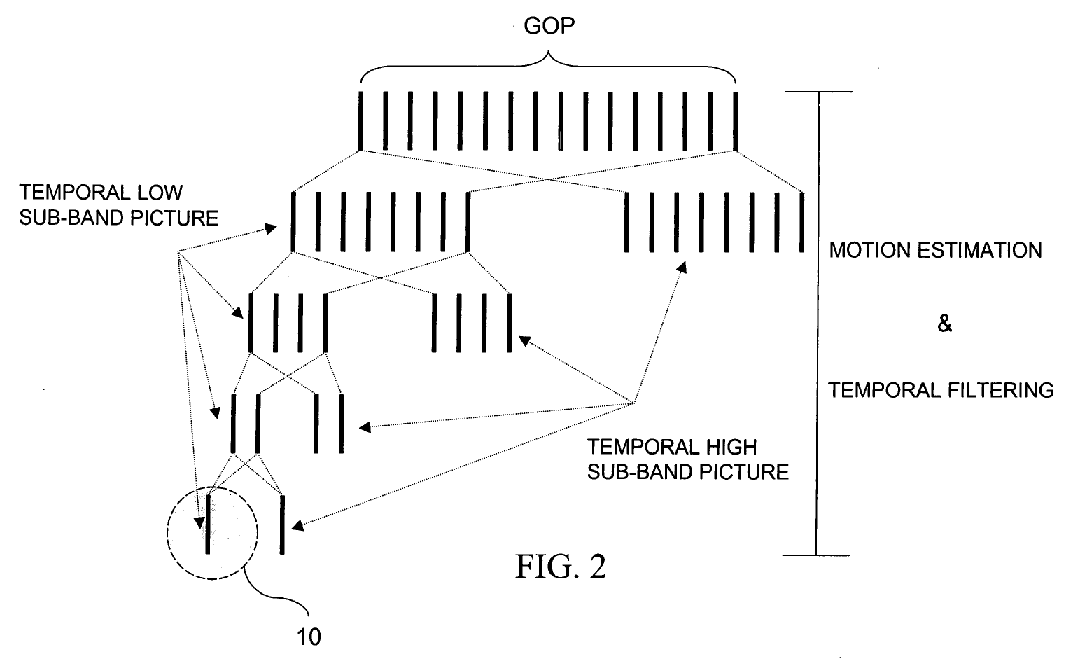

(b) Motion compensated temporal filtering unit 30. Using temporal filtering, a temporal high sub-band picture and a temporal low sub-band picture are produced along the motion vector direction for each consecutive two pictures. After a first level of temporal filtering, the motion compensated temporal filtering unit 30 keeps the high sub-band picture and leaves the temporal low sub-band picture for the next level of temporal filtering. As shown in FIG. 2, after several levels of temporal filtering (FIG. 2 shows the result after four levels of temporal filtering), only a temporal high sub-band picture and a temporal low sub-band picture 10 are kept.

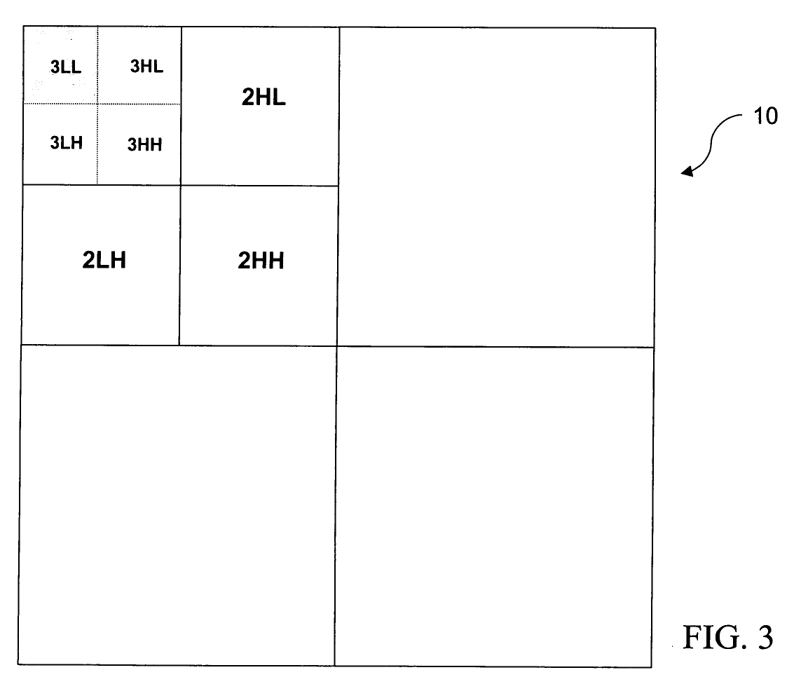

(c) DWT unit 40. It uses the DWT method to process the temporal low sub-band picture 10 generated by the motion compensated temporal filtering unit 30, generating at least one spatial low sub-band, as shown in FIG. 3. When the temporal low sub-band picture 10 goes through one level of DWT, four spatial sub-bands are formed. After a further level of DWT, each original sub-band will be further divided into four sub-bands. The system can repeat this process according the scalability requirement. The more levels of processing there are, the higher the scalability the system has. (FIG. 3 shows the result after three levels of processing.)

(d) Video coding predictive unit 50. It is a main feature of the invention, located between the DWT unit 40 and the video coding unit 60. It is used to make a prediction on the spatial low sub-band generated from the temporal low sub-band picture 10 before video coding. Its operation includes the following two embodiments:

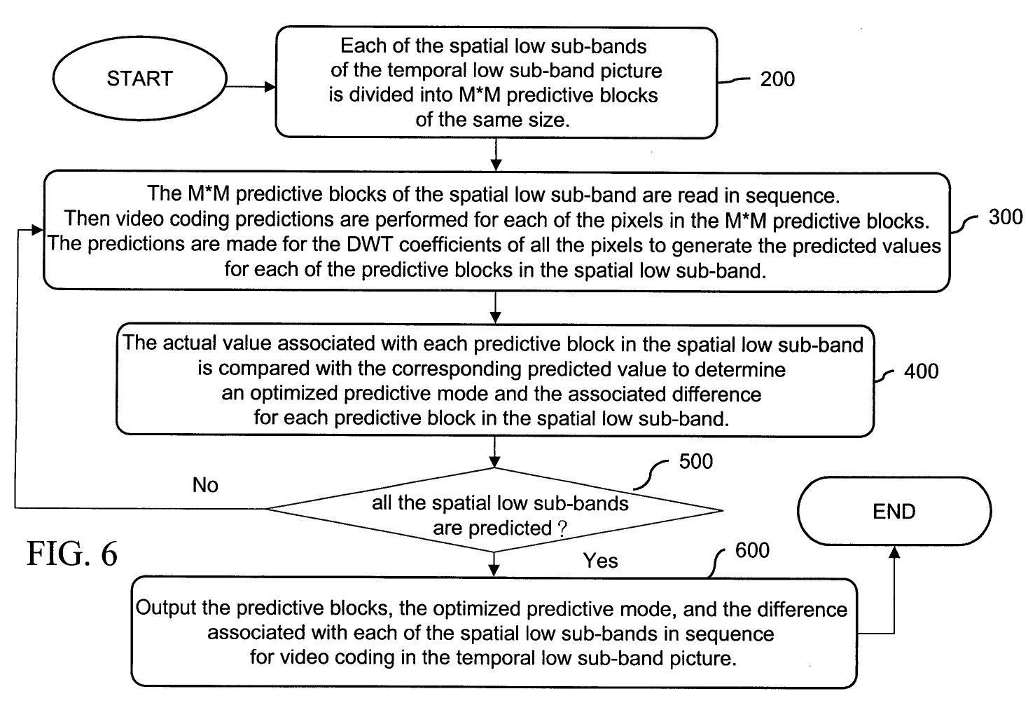

(1) FIG. 6 shows a first embodiment of the operation. First, each of the spatial low sub-bands of the temporal low sub-band picture 10 is divided into M*M predictive blocks of the same size (step 200). The M*M predictive blocks of the spatial low sub-band are read in sequence. Video coding predictions are performed for each of the pixels in the M*M predictive blocks. That is, predictions are made for the DWT coefficients of all the pixels to generate the predicted values for each of the predictive blocks in the spatial low sub-band (step 300). The actual value associated with each predictive block in the spatial low sub-band is compared with the corresponding predicted value to determine an optimized predictive mode and the associated difference for each predictive block in the spatial low sub-band (step 400). The method then determines whether predictions have been done for all the spatial low sub-bands (step 500). As long as there are still spatial low sub-bands to be predicted, the operation returns to step 300 to repeat steps 300 and 400. If all the predictions have been done, then the predictive blocks, the optimized predictive mode, and the difference associated with each of the spatial low sub-bands are output in sequence for video coding in the temporal low sub-band picture 10 (step 600).

In this embodiment, we perform individual predictions for the predictive blocks obtained from the division of each spatial low sub-band in the temporal low sub-band picture 10. Therefore, one prediction is made for each of the predictive blocks and the corresponding optimized predictive mode and difference are output afterwards.

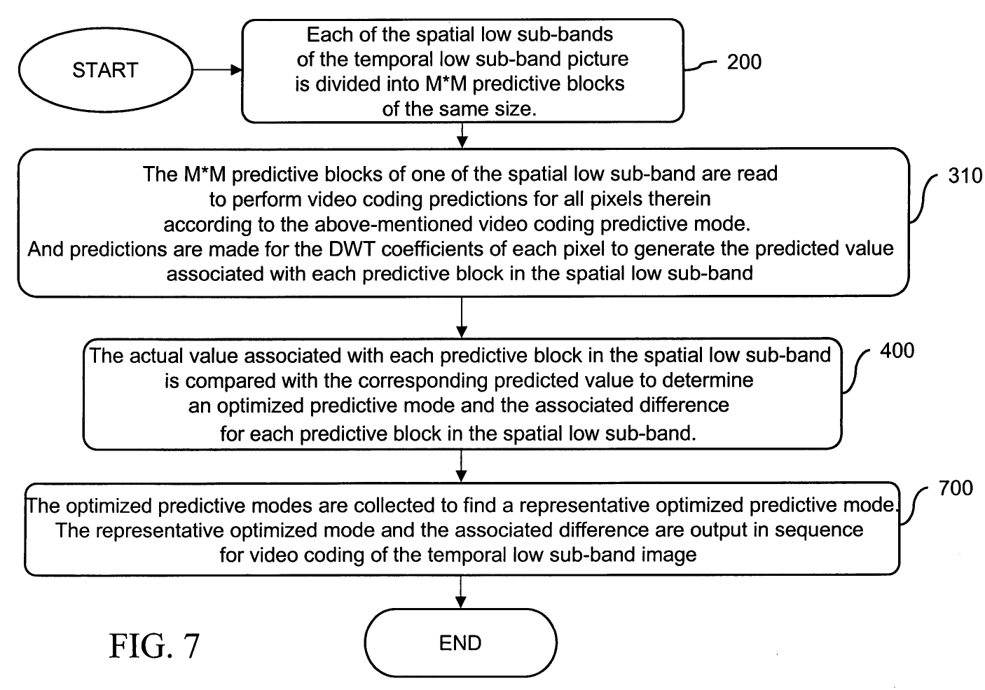

(2) The procedure of the second embodiment is shown in FIG. 7. The steps are generally the same as the first embodiment. First, each of the spatial low sub-bands in the temporal low sub-band picture 10 is divided into M*M predictive blocks of the same size (step 200). The M*M predictive blocks of one of the spatial low sub-band are read to perform video coding predictions for all pixels therein according to the above-mentioned video coding predictive mode. That is, predictions are made for the DWT coefficients of each pixel to generate the predicted value associated with each predictive block in the spatial low sub-band (step 310). The actual value of each predictive block in the spatial low sub-band is compared with the corresponding predicted value to determine an optimized predictive mode and the difference associated with each of the predictive blocks in the spatial low sub-band (step 400). The optimized predictive modes are collected to find a representative optimized predictive mode. The representative optimized mode and the associated difference are output in sequence for video coding of the temporal low sub-band image (step 700).

The difference between the second embodiment and the first embodiment is that in step 310, we only read in a single spatial low sub-band in the temporal low sub-band picture 10 to perform individual predictions for the predictive blocks. In step 700, the optimized predictive mode (i.e. the representative optimized predictive mode) with the highest frequency among the predictive blocks and the associated difference are used as for the output of all spatial low sub-bands in the temporal low sub-band picture 10. This can greatly reduce the required processing procedure and data for the video coding predictive unit 50 to make predictions. This increases the efficiencies in making predictions and overall video coding.

Generally speaking, the size of predictive blocks is either 16*16 or 4*4 (using H.264 as an example). The 16*16 predictive blocks are usually used in predictions of blocks with a smooth variation in the pixel values. The 4*4 predictive blocks are used in predictions of blocks with abrupt changes in the pixel values. The purposes of these two means are different. In the following, we use the 4*4 predictive blocks to explain in detail the video coding predictive mode.

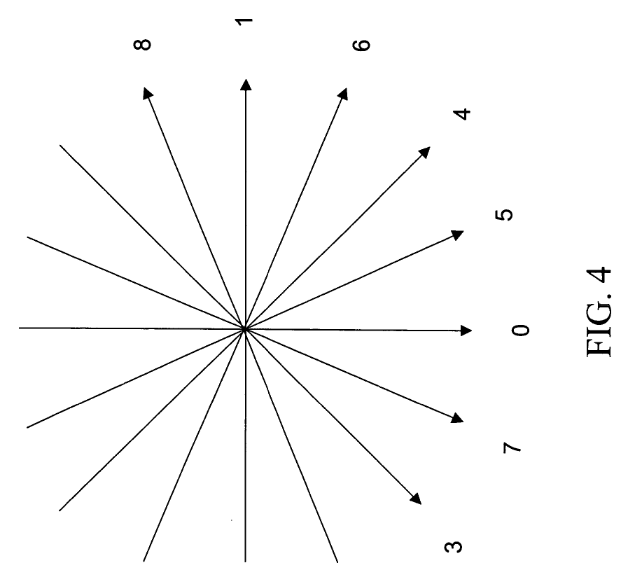

As shown in FIG. 4, the video coding predictive mode means the prediction processing on the predictive blocks in the following nine computing reference directions (i.e. prediction directions): the vertical prediction (mode 0), the horizontal prediction (mode 1), the average prediction (mode 2, not shown), the lower left diagonal prediction (mode 3), the lower right diagonal prediction (mode 4), the vertical right prediction (mode 5), the horizontal low prediction (mode 6), the vertical left prediction (mode 7), and the horizontal up prediction (mode 8).

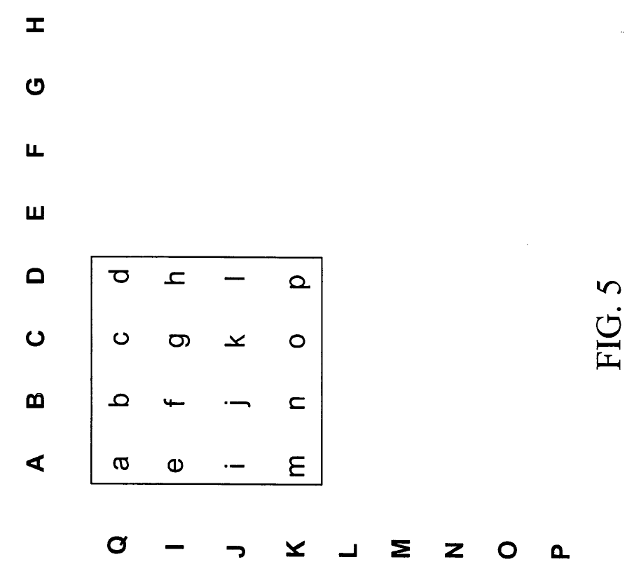

Using the above-mentioned nine computing reference directions along with the following computation method, we can obtain the predicted values of all the video coding predictive modes. With reference to FIG. 5, a, b, c, d, . . . , m, n, o, p represent the 16 pixel values in the 4*4 predictive block, while A, B, C, D, . . . , M, N, O, P represent the reference pixel values around the 4*4 predictive block. (These reference pixel values have to satisfy the basic requirements of belonging to the same picture and the same spatial low sub-band.) The predicted values are estimated using the following computation method:

(1) Vertical prediction (mode 0):

prediction for a, e, i, m are made with reference to A;

prediction for b, f, j, n are made with reference to B;

prediction for c, g, k, o are made with reference to C;

prediction for d, h, l, p are made with reference to D.

(2) Horizontal prediction (mode 1):

prediction for a, b, c, d are made with reference to I;

prediction for e, f, g, h are made with reference to J;

prediction for i, j, k, l are made with reference to K;

prediction for m, n, o, p are made with reference to L.

(3) Average prediction (mode 2):

If all the reference pixel values exist, then predictions for a, b, c, d, . . . , m, n, o, p are made with reference to (A+B+C+D+I+J+K+L+4)>>3;

If only A, B, C, D exist, then predictions for a, b, c, d, . . . , m, n, o, p are made reference to (A+B+C+D+2)>>2;

If only I, J, K, L exist, then the predictions for a, b, c, d, . . . , m, n, o, p are made reference to (I+J+K+L+2)>>2.

(4) Lower left diagonal prediction (mode 3):

a is represented by (A+2B+C+I+2J+K+4)>>3;

b, e are represented by (B+2C+D+J+2K+L+4)>>3;

c, f, i are represented by (C+2D+E+K+2L+M+4)>>3;

d, g, j, m are represented by (D+2E+F+L+2M+N+4)>>3;

h, k, n are represented by (E+2F+G+M+2N+O+4)>>3;

l, o are represented by (F+2G+H+N+2O+P+4)>>3;

p is represented by (G+H+O+P+2)>>2.

(5) Lower right diagonal prediction (mode 4):

m is represented by (J+2K+L+2)>>2;

i, n [symbol] (I+2J+K+2)>>2;

e, j, o are represented by (Q+2I+J+2)>>2;

a, f, k, p are represented by (A+2Q+I+2)>>2;

b, g, l are represented by (Q+2A+B+2)>>2;

c, h are represented by (A+2B+C+2)>>2;

d is represented by (B+2C+D+2)>>2.

(6) Vertical right prediction (mode 5):

a, j are represented by (Q+A+1)>>1;

b, k are represented by (A+B+1)>>1;

c, l are represented by (B+C+1)>>1;

d is represented by (C+D+1)>>1;

e, n are represented by (I+2Q+A+2)>>2;

f, o are represented by (Q+2A+B+2)>>2;

g, p are represented by (A+2B+C+2)>>2;

h is represented by (B+2C+D+2)>>2;

i is represented by (Q+2I+J+2)>>2;

m is represented by (I+2J+K+2)>>2.

(7) Horizontal low prediction (mode 6):

a, g are represented by (Q+I+1)>>1;

b, h are represented by (I+2Q+A+2)>>2;

c is represented by (Q+2A+B+2)>>2;

d is represented by (A+2B+C+2)>>2;

e, k are represented by (I+J+1)>>1;

f, l are represented by (Q+2I+J+2)>>2;

i, o are represented by (J+K+1)>>1;

j, p are represented by (I+2J+K+2)>>2;

m is represented by (K+L+1)>>1;

n is represented by (J+2K+L+2)>>2.

(8) Vertical left prediction (mode 7):

a is represented by (2A+2B+J+2K+L+4)>>4;

b, i are represented by (B+C+1)>>1;

c, j are represented by (C+D+1)>>1;

d, k are represented by (D+E+1)>>1;

l is represented by (E+F+1)>>1;

e is represented by (A+2B+C+K+2L+M+4)>>4;

f, m are represented by (B+2C+D+2)>>2;

g, n are represented by (C+2D+E+2)>>2;

h, o are represented by (D+2E+F+2)>>2;

p is represented by (E+2F+G+2)>>2.

(9) Horizontal up prediction (mode 8):

a is represented by (B+2C+D+2I+2J+4)>>3;

b is represented by (C+2D+E+I+2J+K+4)>>3;

c, e are represented by (J+K+1)>>1;

d, f are represented by (J+2K+L+2)>>2;

g, i are represented by (K+L+1)>>1;

h, j are represented by (K+2L+M+2)>>2;

l, n are represented by (L+2M+N+2)>>2;

k, m are represented by (L+M+1)>>1;

o is represented by (M+N+1)>>1;

p is represented by (M+2N+O+2)>>2.

After computing the predicted value associated with each of the video coding predictive modes in each predictive block, the procedure continues to compare each of the predicted values with the actual values of all the pixels in the predictive block, thereby determining the optimized predictive mode and the corresponding difference for the predictive block. The corresponding difference refers to the sum of absolute differences (SAD) between the predicted value and the actual value for each of the pixels. The optimized predictive mode is the one with the smallest SAD.

In the second embodiment, we also mentioned the so-called representative optimized predictive mode. It is determined by accumulating the number of times of using various optimized predictive modes. The optimized predictive mode with the most times of use becomes the optimized predictive mode used for the whole spatial low sub-band.

(e) Video coding unit 60. It performs entropy coding for the coefficients of the spatial low sub-bands that have not been processed with predictive coding in the DWT unit 40 and for the predictive errors generated by the video coding predictive unit 50.

(f) Motion vector coding unit 70. It performs video coding for the motion vectors estimated by the motion estimating unit 20 from each two consecutive pictures.

(g) Buffering unit 80. It temporarily holds the video coding contents, including the spatial sub-bands, predictive blocks, optimized predictive mode, and the corresponding difference.

Through the implementation of the above-mentioned system and method, according to the temporal low sub-band picture 10 with the largest data amount, we find the optimized predictive mode for each of the spatial low sub-band and the associated difference as the basis for video coding. This can greatly reduce the data during video coding, achieving the effects of increasing the compressing ratio of the SVC structure.

Certain variations would be apparent to those skilled in the art, which variations are considered within the spirit and scope of the claimed invention.

What is claimed is:

1. A system for increasing a scalable video coding (SVC) compressing ratio based upon an SVC structure with a motion estimating unit to make estimates for motion vectors between pictures in a group of pictures (GOP); a motion compensated temporal filtering unit to generate a temporal picture including a temporal low sub-band picture by temporal filtering; a discrete wavelet transform (DWT) unit to process the temporal low sub-band picture using a spatial DWT method to generate at least one spatial low sub-band; a motion vector coding unit to perform video coding of the motion vectors; a video coding unit to perform entropy coding; and a buffering unit to temporarily hold video coding contents; wherein the system comprises:
a video coding predictive unit between the DWT unit and the video coding unit, which divides each of the spatial low sub-bands into M*M predictive blocks of the same size; reads the M*M predictive blocks of the spatial low sub-band in sequence and generates a predicted value for each of the predictive blocks in the spatial low sub-band by making predictions for all the pixels in the M*M predictive blocks according to a video coding predictive mode; computes an actual value associated with each of the predictive blocks in the spatial low sub-band and compares it with the associated predicted value to determine an optimized predictive mode and an associated difference for each of the predictive blocks in the spatial low sub-band; and outputs in sequence the optimized predictive modes and the associated differences of all the predictive blocks of the spatial low sub-bands once their predictions are all made in order to perform entropy coding for the temporal low sub-band picture.

2. The system of claim 1, wherein the M*M predictive block has a size of 4*4.

3. The system of claim 1, wherein the video coding predictions for all the pixels in the M*M predictive blocks are performed on the DWT coefficients of the pixels.

4. The system of claim 1, wherein the video coding predictive mode is selected from the group consisting of an average prediction, a horizontal prediction, a vertical prediction, a right lower diagonal prediction, a left lower diagonal prediction, a vertical left prediction, a vertical right prediction, a horizontal up prediction, and horizontal low prediction.

5. The system of claim 1, wherein the optimized predictive mode has the smallest associated difference.

6. The system of claim 1, wherein the associated difference is the sum of absolute differences (SAD) between the predicted values and the actual values for all the coefficients.

7. A system for increasing a scalable video coding (SVC) compressing ratio based upon an SVC structure with a motion estimating unit to make estimates for motion vectors between pictures in a group of pictures (GOP); a motion compensated temporal filtering unit to generate a temporal picture including a temporal low sub-band picture by temporal filtering; a discrete wavelet transform (DWT) unit to process the temporal low sub-band picture using a spatial DWT method to generate at least one spatial low sub-band; a motion vector coding unit to perform video coding of the motion vectors; a video coding unit to perform entropy coding; and a buffering unit to temporarily hold video coding contents; wherein the system comprises:
a video coding predictive unit between the DWT unit and the video coding unit, which divides each of the spatial low sub-bands into M*M predictive blocks of the same size; reads one of the M*M predictive blocks of the spatial low sub-band and generates a predicted value for each of the predictive blocks in the spatial low sub-band by making predictions for all the pixels in the M*M predictive blocks according to a video coding predictive mode; computes an actual value associated with each of the predictive blocks in the spatial low sub-band and compares it with the associated predicted value to determine an optimized predictive mode and an associated difference for each of the predictive blocks in the spatial low sub-band; and collects the optimized predictive modes to find a representative optimized mode and outputs in sequence the representative optimized predictive mode and the associated difference for performing entropy coding on the temporal low sub-band picture.

8. The system of claim 7, wherein the M*M predictive block has a size of 4*4.

9. The system of claim 7, wherein the video coding predictions for all the pixels in the M*M predictive blocks are performed on the DWT coefficients of the pixels.

10. The system of claim 7, wherein the video coding predictive mode is selected from the group consisting of an average prediction, a horizontal prediction, a vertical prediction, a right lower diagonal prediction, a left lower diagonal prediction, a vertical left prediction, a vertical right prediction, a horizontal up prediction, and horizontal low prediction.

11. The system of claim 7, wherein the optimized predictive mode has the smallest associated difference.

12. The system of claim 7, wherein the associated difference is the SAD between the predicted values and the actual values.

13. The system of claim 7, wherein the representative optimized mode is the optimized predictive mode with the highest number of usage among the predictive blocks in the spatial low sub-band.

14. A method for increasing the SVC compressing ratio by reducing the coding data in a SVC structure, achieved by making intra predictions on more than one spatial low sub-band in a temporal low sub-band picture produced after temporal filtering and spatial DWT on a GOP, the method comprising the steps of:
(a) dividing each of the spatial low sub-band into M*M predictive blocks of the same size;
(b) reading in sequence the M*M predictive blocks of the spatial low sub-band and making video coding predictions for all the pixels in the M*M predictive blocks according to a video coding predictive mode, thereby generating a predicted value for each of the predictive blocks in the spatial low sub-band;
(c) computing an actual value associated with each o the predictive blocks in the spatial low sub-band and comparing it with the corresponding predicted value to determine an optimized predictive mode and an associated difference for each of the predictive blocks in the spatial low sub-band; and
(d) outputting in sequence each of the predictive blocks in the spatial low sub-band, the associated optimized predictive mode, and the associated difference to perform entropy coding for the temporal low sub-band picture;
wherein steps (b) and (c) are repeated if there is still any prediction yet made for the spatial low sub-band, and step (d) is not performed until all the spatial low sub-band predictions are completed.

15. The method of claim 14, wherein the M*M predictive block has a size of 4*4.

16. The method of claim 14, wherein the video coding predictions for all the pixels in the M*M predictive blocks are performed on the DWT coefficients of the pixels.

17. The method of claim 14, wherein the video coding predictive mode is selected from the group consisting of an average prediction, a horizontal prediction, a vertical prediction, a right lower diagonal prediction, a left lower diagonal prediction, a vertical left prediction, a vertical right prediction, a horizontal up prediction, and horizontal low prediction.

18. The method of claim 14, wherein the optimized predictive mode has the smallest associated difference.

19. The method of claim 14, wherein the associated difference is the sum of absolute differences (SAD) between the predicted values and the actual values for all the coefficients.

20. A method for increasing the SVC compressing ratio by reducing the coding data in a SVC structure, achieved by making intra predictions on more than one spatial low sub-band in a temporal low sub-band picture produced after temporal filtering and spatial DWT on a GOP, the method comprising the steps of:
(a) dividing each of the spatial low sub-band into M*M predictive blocks of the same size;
(b) reading one of the M*M predictive blocks of the spatial low sub-band and making video coding predictions for all the pixels in the M*M predictive blocks according to a video coding predictive mode, thereby generating a predicted value for each of the predictive blocks in the spatial low sub-band;
(c) computing an actual value associated with each o the predictive blocks in the spatial low sub-band and comparing it with the corresponding predicted value to determine an optimized predictive mode and an associated difference for each of the predictive blocks in the spatial low sub-band; and
(d) collecting the optimized predictive modes to generate a representative optimized predictive mode and outputting in sequence the representative optimized predictive mode and the associated difference in order to perform entropy coding for the temporal low sub-band picture.

21. The method of claim 20, wherein the M*M predictive block has a size of 4*4.

22. The method of claim 20, wherein the video coding predictions for all the pixels in the M*M predictive blocks are performed on the DWT coefficients of the pixels.

23. The method of claim 20, wherein the video coding predictive mode is selected from the group consisting of an average prediction, a horizontal prediction, a vertical prediction, a right lower diagonal prediction, a left lower diagonal prediction, a vertical left prediction, a vertical right prediction, a horizontal up prediction, and horizontal low prediction.

24. The method of claim 20, wherein the optimized predictive mode has the smallest associated difference.

25. The method of claim 20, wherein the associated difference is the associated difference is the SAD between the predicted values and the actual values.

26. The method of claim 20, wherein the representative optimized mode is the optimized predictive mode with the highest number of usage among the predictive blocks in the spatial low sub-band.
